(19) United States
(12) Patent Application Publication
(10) Pub. No.: US 2026/0287735 A1
(43) Pub. Date: Sep. 24, 2026

(54) Intelligent dual-mode radar system based on a terahertz frequency band and imaging method thereof

(71) Applicant: Shenzhen Cuibo Microsystem Co., Ltd., Shenzhen (CN)

(72) Inventors: Yikang ZHANG, Shenzhen (CN); Yu ZHANG, Shenzhen (CN)

(73) Assignee: Shenzhen Cuibo Microsystem Co., Ltd., Shenzhen (CN)

(21) Appl. No.: 19/189,780

(22) Filed: Apr. 25, 2025

(30) Foreign Application Priority Data
Mar. 24, 2025 (CN) 2025103460166

(51) Int. Cl. G01S 13/89; G01S 7/34; G01S 7/41

(52) U.S. Cl. CPC G01S 13/89; G01S 7/34; G01S 7/41

(57) ABSTRACT

An intelligent dual-mode radar system based on a terahertz frequency band and an imaging method thereof comprises: a transmitting module, which supports dynamic switching between a close-range high-resolution mode and a long-range low-power consumption mode; a receiving module, which is used to receive echo signals reflected by targets of the transmitting module; a frequency synthesizer, which is used to generate adaptive sweep bandwidth and sweep time parameters according to target distance requirements, and preset at least two waveform modes; an adaptive signal processing unit, which is used to dynamically adjust filter parameters and gain according to target distance working modes, and output target imaging data; and a control module, which is used to realize parameter configuration and mode switching of dual-mode collaborative work.

### CROSS-REFERENCE

This application claims the benefit of priority from China Patent Application No. 2025103460166 filed on Mar. 24 2025, the contents of which are hereby incorporated by reference in their entirety.

### TECHNICAL FIELD

The present invention relates to the technical field of terahertz radars, and in particular to an intelligent dual-mode radar system based on a terahertz frequency band and an imaging method thereof.

### BACKGROUND TECHNOLOGY

As an emerging technology, terahertz radars have attracted much attention in recent years due to unique spectrum advantages and potential application value thereof. Terahertz radars have narrow beams and large available bandwidths. These characteristics make terahertz radars have significant advantages in resolution compared with microwave and millimeter wave bands, especially in close-range imaging. At the same time, using gallium nitride amplifier technology, terahertz radars can also achieve long-range imaging, which is of great significance for the detection of speed, position and other indicators of low, small and slow targets.

Due to different detection requirements in different scenarios, traditional single-mode terahertz radars are often unable to dynamically adapt to these requirements and find it difficult to strike a balance between performance and power consumption. First, in a close-range imaging mode, in order to improve resolution, large-bandwidth signals are required, but high power consumption limits the radars' ability to work continuously, which is particularly unfavorable for scenarios that require long-term continuous monitoring. Secondly, in a long-range detection mode, in order to cover long-distance targets, radar systems need to rely on high transmit power, which not only leads to high system complexity, but also significant energy consumption, increasing operating costs and maintenance difficulties.

Therefore, it is necessary to improve the deficiencies in the prior art to solve the above problems.

### SUMMARY OF THE INVENTION

The present invention overcomes the shortcoming of the prior art and provides an intelligent dual-mode radar system based on a terahertz frequency band and an imaging method thereof.

In order to achieve above purposes, the present invention takes following technical solutions: an intelligent dual-mode radar system based on a terahertz frequency band, comprises:
a transmitting module, which is used to generate and emit electromagnetic wave signals in a terahertz frequency band and supports dynamic switching between a close-range high-resolution mode and a long-range low-power consumption mode;
a receiving module, which is used to receive echo signals reflected by targets of the transmitting module, and complete low-noise amplification and mixing processing of signals;
a frequency synthesizer, which is connected to the transmitting module and the receiving module, and used to generate adaptive sweep bandwidth and sweep time parameters according to target distance requirements, and preset at least two waveform modes;
an adaptive signal processing unit, which is connected to the receiving module, and used to dynamically adjust filter parameters and gain according to target distance working modes, and output target imaging data; and a control module, which is connected to the receiving module, the frequency synthesizer and the adaptive signal processing unit, and used to realize parameter configuration and mode switching of dual-mode collaborative work.

In a preferable embodiment of the present invention, the close-range high-resolution mode comprises transmission power <20 dBm, a sweep bandwidth ≥15 GHz, sweep time ≤1.2 ms, and a range resolution is ≤0.025 m; and
the long-range low-power consumption mode comprises transmission power ≥20 dBm, a sweep bandwidth ≤6 GHZ, sweep time ≤0.48 ms, and detection range ≥1000 m.

In a preferable embodiment of the present invention, the frequency synthesizer comprises six preset waveform modes, which comprise:
a close-range waveform mode: detection range of 100^{~}300 m, a sweep bandwidth of 6^{~}15 GHz, and sweep time of 1^{~}1.2 ms; and
a long-range waveform mode: detection range of 1000^{~}1200 m, a sweep bandwidth of 0.3^{~}0.6 GHz, and sweep time of 0.2^{~}0.48 ms.

In a preferable embodiment of the present invention, the transmitting module comprises: a signal generating unit, an amplifier, a power divider, a frequency multiplier chain and a power amplifier connected in sequence;
the signal generating unit is used to generate signals of a frequency band of 8.5^{~}9.5 GHz;
the frequency multiplier chain is used to increase a frequency band of baseband signals to 210^{~}225 GHz through an ×12 frequency multiplication module and an ×2 frequency multiplication module; and
the power amplifier is used to output power ≥20 dBm in a long-range mode and <20 dBm in a close-range mode.

In a preferable embodiment of the present invention, the receiving module comprises: a receiving antenna, a low noise amplifier, a harmonic mixer and an intermediate frequency output link connected in sequence;
the receiving antenna is used to receive echo signals of 210^{~}225 GHz;
the harmonic mixer is used to mix the echo signals with local oscillator signals to obtain intermediate frequency signals of 100 KHz^{~}10 MHz; and
the intermediate frequency output link is used to convert mixed signals into intermediate frequency signals of 100 KHz^{~}10 MHz, which are input into the adaptive signal processing unit.

In a preferable embodiment of the present invention, the adaptive signal processing unit comprises: a close-range imaging algorithm module and a long-range detection algorithm module;
the close-range imaging algorithm module is used to use fast Fourier transform (FFT) imaging algorithms to achieve three-dimensional imaging with a centimeter-level resolution; and
the long-range detection algorithm module uses a moving target detection filter to suppress noise waves and improves a signal-to-noise ratio to ≥10 dB based on dynamic gain adjustment.

In a preferable embodiment of the present invention, the control module comprises: a microprocessor, a control unit and a radar turntable connected in sequence;
the microprocessor is used to receive intermediate frequency signals from the receiving module through an analog-to-digital converter, perform data processing, and communicate with the control unit and the radar turntable through communication interfaces;
the control unit is used to interact with the frequency synthesizer and the adaptive signal processing unit through communication interfaces; and
the radar turntable is used to drive antenna arrays to achieve 360° scanning with angular accuracy of ≤±0.1°.

The present invention provides an imaging method of the intelligent dual-mode radar system based on a terahertz frequency band according to any of claims 1^{~}7, comprising following steps of:
S1—selecting the close-range high-resolution mode or the long-range low-power consumption mode according to target distances, and generating corresponding frequency sweep signals through the frequency synthesizer;
S2—in the close-range high-resolution mode, receiving echo signals, and realizing high-resolution three-dimensional reconstruction through large bandwidth signals and an FFT imaging algorithm; and
S3—in the long-range low-power consumption mode, receiving echo signals, and realizing low-power consumption target recognition through narrow bandwidth signals and a moving target detection algorithm.

In a preferable embodiment of the present invention, in S2, a range resolution of the close-range high-resolution mode is calculated as follows:

$$Δ R = C / ( 2 f ) ,$$

where C represents a speed of light and f represents a sweep bandwidth; and when f≥20 GHZ, ΔR≤0.025 m.

In a preferable embodiment of the present invention, in S3, a detection range of the long-range low-power consumption mode is calculated as follows:

$$R = ( C \cdot T \cdot τ ) / ( 2 Δ f ) ,$$

where T represents sweep time, τ represents target reflection delay, and Δf represents signal frequency difference; and when Δf≤0.6 GHz and T≤0.48 ms, R ≥1000 m.

The present invention solves the defects existing in the background technology and has following beneficial effects:
I. The present invention provides an intelligent dual-mode radar system based on a terahertz frequency band and imaging method thereof. The dual-mode radar collaborative architecture of the present invention realizes the collaborative work of close-range high-resolution imaging and long-range low-power detection through a dynamic frequency synthesizer and adaptive signal processing technology. The system adopts a dual-mode switching mechanism that links hardware parameter presets with software algorithms, which can realize the collaborative work of close-range high-resolution imaging and long-range low-power consumption detection, solving the performance bottleneck of traditional single-mode radars and being suitable for efficient target detection and imaging requirements in diversified scenarios.
II. In the present invention, six waveform modes are preset through a frequency synthesizer, combined with real-time filtering and gain adjustment of an adaptive signal processing unit, which can automatically match the optimal sweep bandwidth and frequency range according to the detection range requirements, thereby improving the system flexibility and response speed, thereby achieving more accurate detection and imaging.
III. In the present invention, within the frequency band of 210^{~}225 GHZ, the transmission power is controlled within the range of ≤20 dBm, and the power output is stable with small fluctuations, indicating that the transmission module can maintain stable low-power output under a large bandwidth to ensure that the receiver will not be oversaturated under the condition of low-power dynamic attenuation, thereby optimizing the signal-to-noise ratio and achieving high-resolution imaging.
IV. In the present invention, within the frequency band of 219^{~}225 GHZ, by reasonably setting parameters such as sweep time and bandwidth, the advantages of this frequency band can be fully utilized, so that the weak signal reflected by the long-distance target can be more effectively received and amplified, thereby improving the system's detection probability and accuracy for low, small and slow targets, and achieving effective detection of targets at a distance of more than 1000 meters.

### BRIEF DESCRIPTION OF THE DRAWINGS

In order to more clearly illustrate the embodiments of the present invention or the technical solutions in the prior art, the drawings required for use in the embodiments or the description of the prior art are briefly introduced below. Obviously, the drawings described below are only some embodiments recorded in the present invention. For those of ordinary skill in the art, other drawings can be obtained based on these drawings without creative work.

FIG. 1 is a block diagram of an intelligent dual-mode radar system of the present invention.

FIG. 2 is a power test curve of a mode A of a preferred embodiment of the present invention.

FIG. 3 is a test curve of frequency conversion gain of a mode B of a preferred embodiment of the present invention.

FIG. 4 is a test curve of long-range mode noise coefficients of a preferred embodiment of the present invention.

FIG. 5 is a three-dimensional imaging interface diagram of control software of a preferred embodiment of the present invention.

FIG. 6 is a close-range imaging diagram of a preferred embodiment of the present invention.

FIG. 7 is a long-range imaging diagram of a preferred embodiment of the present invention.

### SPECIFIC EMBODIMENTS

The following will be combined with the drawings in the embodiments of the present invention to clearly and completely describe the technical solutions in the embodiments of the present invention. Obviously, the described embodiments are only some embodiments of the present invention, not all of the embodiments. Based on the embodiments of the present invention, all other embodiments obtained by ordinary technicians in this field without creative work are within the scope of protection of the present invention.

In the following description, many specific details are set forth to facilitate a full understanding of the present invention, but the present invention may also be implemented in other ways different from those described herein. Therefore, the protection scope of the present invention is not limited to the specific embodiments disclosed below.

In the description of the present invention, it should be noted that, unless otherwise clearly specified and limited, the terms “installed”, “connected”, and “connected” should be understood in a broad sense, for example, it can be a fixed connection, a detachable connection, or an integral connection; it can be a mechanical connection or an electrical connection; it can be directly connected or indirectly connected through an intermediate medium, and it can be the internal communication of two components. For ordinary technicians in this field, the specific meanings of the above terms in the present invention can be understood by specific circumstances.

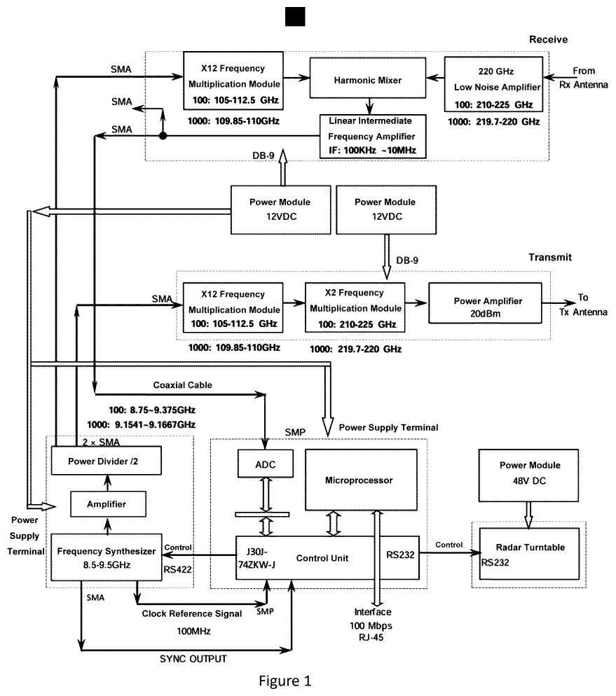

As shown in FIG. 1, an intelligent dual-mode radar system based on a terahertz frequency band, comprises: a transmitting module, which is used to generate and emit electromagnetic wave signals in a terahertz frequency band and supports dynamic switching between a close-range high-resolution mode and a long-range low-power consumption mode; a receiving module, which is used to receive echo signals reflected by targets of the transmitting module, and complete low-noise amplification and mixing processing of signals; a frequency synthesizer, which is connected to the transmitting module and the receiving module, and used to generate adaptive sweep bandwidth and sweep time parameters according to target distance requirements, and preset at least two waveform modes; an adaptive signal processing unit, which is connected to the receiving module, and used to dynamically adjust filter parameters and gain according to target distance working modes, and output target imaging data; and a control module, which is connected to the receiving module, the frequency synthesizer and the adaptive signal processing unit, and used to realize parameter configuration and mode switching of dual-mode collaborative work.

It should be noted that the close-range high-resolution mode adopts an electronically controlled attenuator to achieve a low output power of transmission power <20 dBm to ensure that a receiver is not oversaturated, a sweep bandwidth is ≥15 GHz, sweep time is ≤1.2 ms, the signal-to-noise ratio is optimized and range resolution is ≤0.025 m; and the long-range low-power consumption mode uses an electrically controlled attenuator to achieve a high output power of transmission power ≥20 dBm, so as to ensure long-range operation, a sweep bandwidth ≤6 GHZ, sweep time ≤0.48 ms, ultra-short sweep time, improved power utilization, and a detection range ≥1000 m. The system further comprises several power modules (such as 12 VDC and 48 VDC) to provide required power for different modules to ensure normal operation of each module.

Specifically, dual-mode radar collaborative architecture of the present invention realizes the collaborative work of close-range high-resolution imaging and long-range low-power detection through dynamic frequency synthesizer and adaptive signal processing technology. The system adopts a dual-mode switching mechanism that links hardware parameter presets with software algorithms, which can realize the collaborative work of close-range high-resolution imaging and long-range low-power detection, solving the performance bottleneck of traditional single-mode radars and is suitable for efficient target detection and imaging needs in diversified scenarios.

In some embodiments, the frequency synthesizer comprises six preset waveform modes, and the preset waveform modes comprise: a close-range waveform mode: a detection range 100^{~}300 m, a sweep bandwidth 6^{~}15 GHZ, and sweep time 1^{~}1.2 ms; a long-range waveform mode: a detection range 1000^{~}1200 m, a sweep bandwidth 0.3^{~}0.6 GHz, and sweep time 0.2^{~}0.48 ms.

It should be noted that through the frequency synthesizer, six waveform modes are preset, combined with the real-time filtering and gain adjustment of the adaptive signal processing unit, optimal scanning bandwidth and frequency range can be automatically matched according to the detection range requirements, thereby improving the system flexibility and response speed, thereby achieving more accurate detection and imaging.

In some embodiments, the transmitting module comprises: a signal generating unit, an amplifier, a power divider, a frequency multiplier chain and a power amplifier connected in sequence; the signal generating unit is used to generate signals of a frequency band of 8.5^{~}9.5 GHZ; the frequency multiplier chain is used to increase a frequency band of baseband signals to 210^{~}225 GHz through an ×12 frequency multiplication module and an ×2 frequency multiplication module; and the power amplifier is used to output power ≥20 dBm in a long-range mode and <20 dBm in a close-range mode.

In some embodiments, the receiving module comprises: a receiving antenna, a low noise amplifier, a harmonic mixer and an intermediate frequency output link connected in sequence; the receiving antenna is used to receive echo signals of 210^{~}225 GHz; the harmonic mixer is used to mix the echo signals with local oscillator signals to obtain intermediate frequency signals of 100 KHz^{~}10 MHz; and the intermediate frequency output link is used to convert mixed signals into intermediate frequency signals of 100 KHz^{~}10 MHz, which are input into the adaptive signal processing unit.

In some embodiments, the adaptive signal processing unit comprises: a close-range imaging algorithm module and a long-range detection algorithm module; the close-range imaging algorithm module is used to use a fast Fourier transform (FFT) imaging algorithm to achieve three-dimensional imaging with a centimeter-level resolution; and the long-range detection algorithm module uses a moving target detection filter to suppress noise waves and improves a signal-to-noise ratio to ≥10 dB based on dynamic gain adjustment.

In some embodiments, the control module comprises: a microprocessor, a control unit and a radar turntable connected in sequence; the microprocessor is used to receive intermediate frequency signals from the receiving module through an analog-to-digital converter (ADC), perform data processing, and communicate with the control unit and the radar turntable through communication interfaces; the control unit is used to interact with the frequency synthesizer and the adaptive signal processing unit through communication interfaces; and the radar turntable is used to drive antenna arrays to achieve 360° scanning with angular accuracy of ≤±0.1°.

When the present invention is used, the close-range waveform mode and the long-range waveform mode are preset by the frequency synthesizer, and the close-range high-resolution or long-range low-power consumption mode is selected according to the target distance. The signal generating unit generates 8.5^{~} 9.5 GHz and generated signals are amplified by the amplifier to provide signals of sufficient strength for subsequent frequency multiplication and other operations. The power divider is used to divide amplified signals into two paths, a first path passes through the ×12 frequency multiplication module of the frequency multiplier chain to increase signals to a frequency band of 100^{~}112.5 GHZ, then is output into a frequency band of 210^{~}225 GHz through the ×2 frequency multiplication module, and is power amplified by the power amplifier, and finally transmitted through a transmitting antenna; the second path passes through the ×12 frequency multiplication module of the frequency multiplier chain to increase the signals to a frequency band of 100^{~}112.5 GHz as a local oscillator signal. At the same time, the receiving antenna receives echo signals of 210^{~}225 GHz, performs low-noise amplification through the low-noise amplifier, and mixes received echo signals with local oscillator signals through the harmonic mixer to obtain IF signals, whose frequency range fall 100 KHz^{~}10 MHz, and the IF signals are output to the adaptive signal processing unit and the control module through the intermediate frequency output link. The control module receives the IF signals through the ADC, and the microprocessor performs data processing and other operations. At the same time, communication with the control unit and the radar turntable is achieved through various interfaces (such as RS232, RS422, J30J, etc.), in which the radar turntable and the antenna array realize multi-angle scanning, and combine the close-range imaging algorithm module or the long-range detection algorithm module of the adaptive signal processing unit to achieve high-precision positioning and imaging of targets, and improve imaging efficiency and accuracy.

An imaging method of the intelligent dual-mode radar system based on a terahertz frequency band comprises following steps of:
S1—selecting the close-range high-resolution mode or the long-range low-power consumption mode according to target distances, and generating corresponding frequency sweep signals through the frequency synthesizer;
S2—in the close-range high-resolution mode, receiving echo signals, and realizing high-resolution three-dimensional reconstruction through large bandwidth signals and an FFT imaging algorithm; and
S3—in the long-range low-power consumption mode, receiving echo signals, and realizing low-power consumption target recognition through narrow bandwidth signals and a moving target detection algorithm.

It should be noted that the FFT imaging algorithm is based on the frequency domain analysis of radar echo signals, which converts time domain signals into frequency domain information, and extracts distance and azimuth characteristics of the targets to achieve real-time imaging with centimeter-level resolution. The moving target detection algorithm distinguishes between stationary backgrounds and moving targets through the Doppler frequency shift and clutter suppression technology of signals, and achieves efficient identification of kilometer-level targets under low power consumption conditions. Application principles and coding thereof are all existing technical means known to technicians in this field and belong to common knowledge in this field. Therefore, the present invention will not explain them in detail and will not be elaborated here.

In some embodiments of the present invention, in S2, range resolution of the close-range high-resolution mode is calculated as follows:

$$Δ R = C / ( 2 f ) ,$$

where C represents speed of light and f represents sweep bandwidth; and when f ≥20 GHZ, ΔR≤0.025 m.

In some embodiments of the present invention, in S3, detection range of the long-range low-power consumption mode is calculated as follows:

$$R = ( C \cdot T \cdot τ ) / ( 2 Δ f ) ,$$

where T represents sweep time, τ represents target reflection delay, and Δf represents signal frequency difference; and when Δf≤0.6 GHz and T≤0.48 ms, R ≥1000 m.

In order to further make the purposes and effects of the present invention simple and easy to understand, the present invention is further elaborated in combination with the following embodiments.

### Embodiment

The intelligent dual-mode radar system in the present embodiment: supports a large-bandwidth close-range high-resolution mode (mode A) and a small-bandwidth long-range low-power mode (mode B), as detailed in Table 1.

TABLE 1

| | Close-range | Long-range |
|---|---|---|
| | 100 m mode | 1000 m mode |
| Technical parameters | (Mode A) | (Mode B) |
| Frequency range | DC-10 GHz | |
| Minimum output power | 5 dBm | |
| Power flatness | 1 dB | |
| Frequency sweep time | 0.2 ms-10 ms | |
| Sweep linearity | Better than 0.1% | |
| Clutter suppression | −45 dBc | |
| Harmonic suppression | −45 dBc | |
| Radio frequency output | 2.92 Coaxial | |
| port | | |
| Clock frequency | 100 MHz | |
| Communication interface | RS422 | |
| Power supply | 12 V/5 W | |
| Output frequency | 8.75 GHz~9.375 GHz | 9.14166667- |
| (transmit) | | 9.16666667 |
| Output frequency | 8.75 GHz~9.375 GHz | 9.14166667- |
| (receive) | | 9.16666667 |
| Frequency sweep time | 1 ms | 0.48 ms |

| | |
|---|---|
| Alternative mode (can be | Slope unchanged, and sweep time: |
| called directly) | 0.2 ms~1.2 ms |
| Output clock waveform | TTL |
| format | |
| Output clock | 100 MHz/SMA-F |
| reference/interface | |
| Synchronous signal | SMA |
| output | |
| Control | Signal processing software unified control/open |
| software/interface | interface |

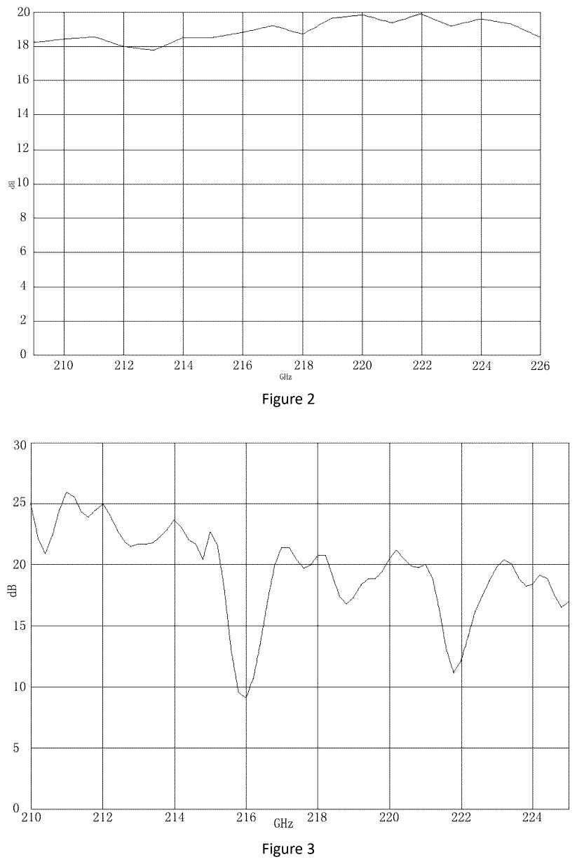

The transmit power characteristics of the mode A are measured by using a VDI/PM5 power meter. The results are shown in FIG. 2. In the 210-225 GHz frequency band, the transmit power is controlled within the range of ≤20 dBm, and the power output is stable with small fluctuations, indicating that the transmit module can maintain stable low-power output over a large bandwidth to ensure that the receiver will not be oversaturated under low-power dynamic attenuation conditions, thereby optimizing the signal-to-noise ratio and achieving high-resolution imaging.

The PNA network analyzer is used to measure the frequency conversion gain characteristics of mode B. The results are shown in FIG. 3. In the frequency band of 219-225 GHZ, although the gain fluctuates, the overall frequency conversion capability is still available. By reasonably setting parameters such as the sweep time and bandwidth, the advantages of this frequency band can be fully utilized, so that the weak signals reflected by distant targets can be more effectively received and amplified, thereby improving the system's detection probability and accuracy for low, small and slow targets, and achieving effective detection of targets more than 1000 meters away.

The frequency synthesizer presets six waveform modes, see table 2 for details, which are used to automatically match the detection range requirements.

TABLE 2

| Waveform mode | 1 | 2 | 3 | 4 | 5 | 6 |
|---|---|---|---|---|---|---|
| Detection | 100 | 100 | 300 | 1000 | 1000 | 1200 |
| range (m) | | | | | | |
| Sweep | 15 | 6 | 6 | 0.3 | 0.6 | 0.6 |
| bandwidth | | | | | | |
| (GHz) | | | | | | |
| Frequency | 1 | 0.4 | 1.2 | 0.2 | 0.4 | 0.48 |
| sweep time | | | | | | |
| (ms) | | | | | | |
| Velocity of | 300000000 | | | | | |
| light (m/s) | | | | | | |
| Interval | 0.0006667 | 0.0006667 | 0.002 | 0.0006667 | 0.0006667 | 0.008 |
| time (ms) | | | | | | |
| Target | 10 | | | | | |
| transmitting | | | | | | |
| signal | | | | | | |
| frequency | | | | | | |
| difference | | | | | | |
| (MHz) | | | | | | |
| IF output | 0-10 | | | | | |
| frequency | | | | | | |
| (MHz) | | | | | | |
| Range | 0.01 | 0.025 | 0.025 | 0.5 | 0.25 | 0.25 |
| resolution | | | | | | |
| (m) | | | | | | |
| Frequency | 8.75-9.375 | 9.125-9.375 | 9.125-9.375 | 9.2417-9.2542 | 9.2375-9.2625 | 9.1417-9.1667 |
| synthesis | | | | | | |
| start and | | | | | | |
| end | | | | | | |
| frequency | | | | | | |
| (GHz) | | | | | | |
| Radio | 210-225 | 219-225 | 219-225 | 221.8-222.1 | 221.7-222.3 | 219.4-220 |
| frequency | | | | | | |
| scanning | | | | | | |
| frequency | | | | | | |
| (GHz) | | | | | | |

The adaptive signal processing unit dynamically adjusts filter parameters and gain according to target distances.

Three-dimensional radar turntable and antenna array support 360° scanning and multi-angle imaging.

### Working Principle:

Mode A: frequency band: 210-225 GHz (large bandwidth 20 GHz); power: ≤20 dBm (low power dynamic attenuation); resolution: range resolution ≤0.025 m (based on the range resolution formula); applicable scenarios: high-precision imaging within 100 meters (such as personnel positioning, small object detection); and an electrically controlled attenuator is used to achieve a low output power of <20 dBm to ensure that the receiver is not oversaturated, a 15 GHz bandwidth, 1 ms sweep time, and an optimized signal-to-noise ratio.

Mode B: frequency band: 219-225 GHz (small bandwidth 6 GHZ); power: ≥20 dBm (high power dynamic compensation); scanning range: more than 1000 meters; applicable scenarios: long-distance target detection (such as building outlines, terrain mapping), low, small and slow targets; and an electrically controlled attenuator ≥20 dBm high output power is used to ensure long-distance work, and improve power utilization through 0.3 GHz narrow bandwidth and 0.2 ms ultra-short sweep time.

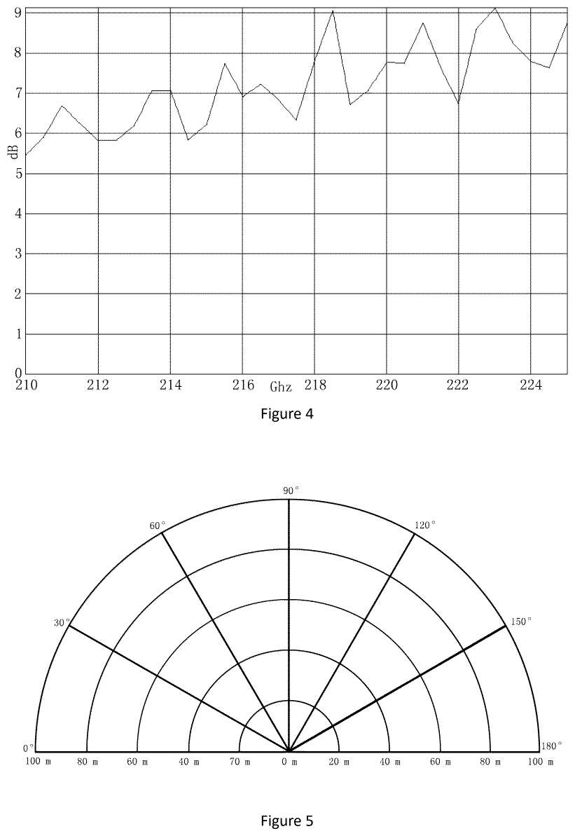

Adaptive noise suppression algorithm: the Y-factor method noise test data is used as shown in FIG. 4 to dynamically adjust the intermediate frequency gain in the long-range mode and reduce the impact of thermal noise.

Hardware-algorithm collaboration: as shown in FIG. 5, based on the turntable angle accuracy (±0.1°) and sampling rate (8192 pps), high-precision 3D imaging reconstruction is achieved.

### Field Test:

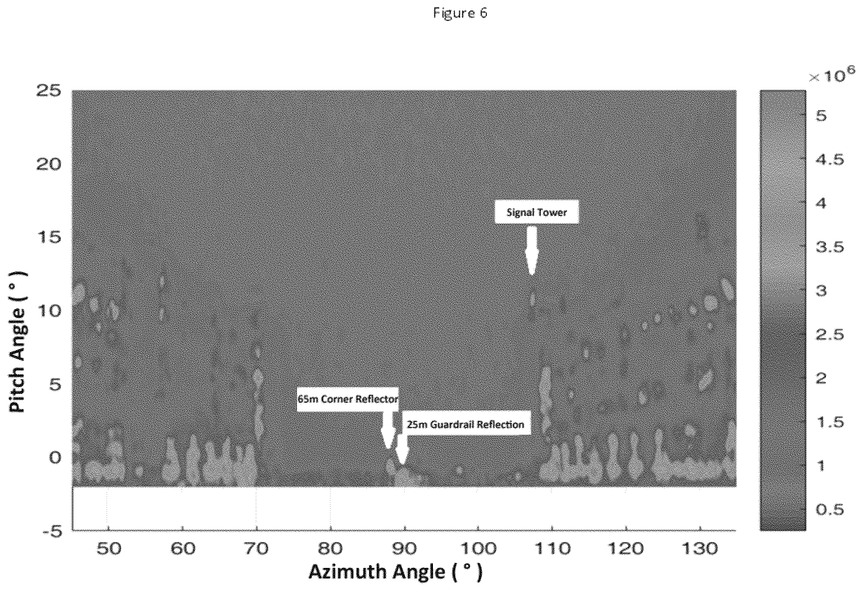

As shown in FIG. 6, short-range imaging (100 m): a horizontal resolution ±0.1°, and a pitch resolution ±0.1°.

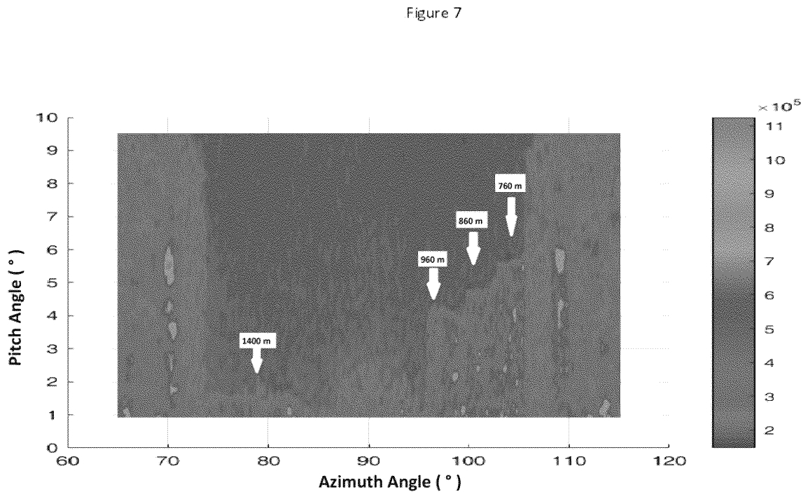

As shown in FIG. 7, long-range imaging (1200 m): a signal-to-noise ratio ≥10 dB, and a target recognition rate ≥95%.

In summary, the present invention enables the system to have both the ability to “see clearly” and “see far” in complex environments through dynamic switching and hardware collaboration, significantly expanding the application boundaries of terahertz radar.

The above is based on the ideal embodiment of the present invention. Through the above description, it is obvious to those skilled in the art that the present invention is not limited to the details of the above exemplary embodiments, and the present invention can be implemented in other specific forms without departing from the spirit or basic characteristics of the present invention. Therefore, no matter from which point of view, the embodiments should be regarded as exemplary and non-restrictive, the scope of the present invention is limited by the attached claims rather than the above description, and it is intended to include all changes within the meaning and scope of the equivalent elements of the claims. Any figure mark in the claims should not be regarded as limiting the claims involved.

In addition, it should be understood that although the present specification is described according to implementation modes, not every implementation mode contains only one independent technical solution. This description of the specification is only for the sake of clarity. Those skilled in the art should regard the specification as a whole. The technical solutions in each embodiment may also be appropriately combined to form other implementation modes that can be understood by those skilled in the art.

1. An intelligent dual-mode radar system based on a terahertz frequency band, comprising:
a transmitting module, which is used to generate and emit electromagnetic wave signals in a terahertz frequency band and supports dynamic switching between a close-range high-resolution mode and a long-range low-power consumption mode;
a receiving module, which is used to receive echo signals reflected by targets of the transmitting module, and complete low-noise amplification and mixing processing of signals;
a frequency synthesizer, which is connected to the transmitting module and the receiving module, and used to generate adaptive sweep bandwidth and sweep time parameters according to target distance requirements, and preset at least two waveform modes;
an adaptive signal processing unit, which is connected to the receiving module, and used to dynamically adjust filter parameters and gain according to target distance working modes, and output target imaging data; and
a control module, which is connected to the receiving module, the frequency synthesizer and the adaptive signal processing unit, and used to realize parameter configuration and mode switching of dual-mode collaborative work.

2. The intelligent dual-mode radar system based on a terahertz frequency band according to claim 1, wherein the close-range high-resolution mode comprises transmission power <20 dBm, a sweep bandwidth ≥15 GHz, sweep time ≤1.2 ms, and a range resolution is ≤0.025 m; and
the long-range low-power consumption mode comprises transmission power ≥20 dBm, a sweep bandwidth ≤6 GHZ, sweep time ≤0.48 ms, and a detection range ≥1000 m.

3. The intelligent dual-mode radar system based on a terahertz frequency band according to claim 1, wherein the frequency synthesizer comprises six preset waveform modes, which comprise:
a close-range waveform mode: a detection range of 100^{~}300 m, a sweep bandwidth of 6^{~}15 GHz, and sweep time of 1^{~}1.2 ms; and
a long-range waveform mode: a detection range of 1000^{~}1200 m, a sweep bandwidth of 0.3^{~}0.6 GHZ, and sweep time of 0.2^{~}0.48 ms.

4. The intelligent dual-mode radar system based on a terahertz frequency band according to claim 1, wherein the transmitting module comprises: a signal generating unit, an amplifier, a power divider, a frequency multiplier chain and a power amplifier connected in sequence;
the signal generating unit is used to generate signals of a frequency band of 8.5^{~}9.5 GHZ;
the frequency multiplier chain is used to increase a frequency band of baseband signals to 210^{~}225 GHz through an ×12 frequency multiplication module and an ×2 frequency multiplication module; and
the power amplifier is used to output power ≥20 dBm in a long-range mode and <20 dBm in a close-range mode.

5. The intelligent dual-mode radar system based on a terahertz frequency band according to claim 1, wherein the receiving module comprises: a receiving antenna, a low noise amplifier, a harmonic mixer and an intermediate frequency output link connected in sequence;
the receiving antenna is used to receive echo signals of 210^{~}225 GHZ;
the harmonic mixer is used to mix the echo signals with local oscillator signals to obtain intermediate frequency signals of 100 KHz^{~}10 MHz; and
the intermediate frequency output link is used to convert mixed signals into intermediate frequency signals of 100 KHz^{~}10 MHz, which are input into the adaptive signal processing unit.

6. The intelligent dual-mode radar system based on a terahertz frequency band according to claim 1, wherein the adaptive signal processing unit comprises: a close-range imaging algorithm module and a long-range detection algorithm module;
the close-range imaging algorithm module is used to use a fast Fourier transform (FFT) imaging algorithm to achieve three-dimensional imaging with a centimeter-level resolution; and
the long-range detection algorithm module uses a moving target detection filter to suppress noise waves and improves a signal-to-noise ratio to ≥10 dB based on dynamic gain adjustment.

7. The intelligent dual-mode radar system based on a terahertz frequency band according to claim 1, wherein the control module comprises: a microprocessor, a control unit and a radar turntable connected in sequence;
the microprocessor is used to receive intermediate frequency signals from the receiving module through an analog-to-digital converter, perform data processing, and communicate with the control unit and the radar turntable through communication interfaces;
the control unit is used to interact with the frequency synthesizer and the adaptive signal processing unit through communication interfaces; and
the radar turntable is used to drive antenna arrays to achieve 360° scanning with angular accuracy of ≤±0.1°.

8. An imaging method of the intelligent dual-mode radar system based on a terahertz frequency band according to claim 1, comprising following steps of:
S1—selecting the close-range high-resolution mode or the long-range low-power consumption mode according to target distances, and generating corresponding frequency sweep signals through the frequency synthesizer;
S2—in the close-range high-resolution mode, receiving echo signals, and realizing high-resolution three-dimensional reconstruction through large bandwidth signals and an FFT imaging algorithm; and
S3—in the long-range low-power consumption mode, receiving echo signals, and realizing low-power consumption target recognition through narrow bandwidth signals and a moving target detection algorithm.

9. The imaging method of the intelligent dual-mode radar system based on a terahertz frequency band according to claim 8, wherein in S2, a range resolution of the close-range high-resolution mode is calculated as follows:
$$Δ R = C / ( 2 f ) ,$$
where C represents a speed of light and f represents a sweep bandwidth; and when f ≥20 GHZ, ΔR≤0.025 m.

10. The imaging method of the intelligent dual-mode radar system based on a terahertz frequency band according to claim 8, wherein in S3, a detection range of the long-range low-power consumption mode is calculated as follows:
$$R = ( C \cdot T \cdot τ ) / ( 2 Δ f ) ,$$
where T represents sweep time, t represents target reflection delay, and Δf represents signal frequency difference; and when Δf≤0.6 GHz and T≤0.48 ms, R≥1000 m.
